(19) United States
(12) Patent Application Publication
(10) Pub. No.: US 2026/0270651 A1
(43) Pub. Date: Sep. 10, 2026

(54) METHOD, DEVICE, AND SYSTEM FOR MONITORING CREATURES IN AIRPORTS USING BLUETOOTH LOW ENERGY (BLE) TAGS

(71) Applicant: HCL Technologies Limited, New Delhi (IN)

(72) Inventors: Saunak Sahoo, Redmond, WA (US); Eshaan Khurana, Redmond, WA (US); Pankaj Gupta, Edmonds, WA (US)

(21) Appl. No.: 19/071,807

(22) Filed: Mar. 6, 2025

(51) Int. Cl. H04W 4/029; H04L 41/22; H04W 4/80

(52) U.S. Cl. CPC H04W 4/029; H04L 41/22; H04W 4/80

(57) ABSTRACT

This disclosure relates to method, device, and system for monitoring creatures in airports using Bluetooth Low Energy (BLE) tags is disclosed. The method may include retrieving details of a creature in an airport based on a boarding pass associated with the creature. The method may further include mapping details of the creature to a tag configured to be worn by the creature. The method may include iteratively receiving a first signal from a BLE beacon of the tag worn by the creature. The method may further include determining a distance of the tag from an end-device based on the first signal. The method may include displaying a colour-coded distance zone from a set of colour-coded distance zones, based on the determined distance. Each of the set of colour-coded distance zones are associated with a predefined range of the tag relative to the end-device.

### DESCRIPTION

### Technical Field

This invention generally relates to the field of wireless tags, and more particularly to method, device and system for monitoring creatures in airports using Bluetooth Low Energy (BLE) tags.

### Background

Various solutions are currently available for tracking a creature or an object. Examples of the creature may include a traveller, a differently abled person, a minor, or a pet. In a similar manner, examples of the object may include a suitcase, a laptop, a smart phone, a handbag, or a wallet. Examples of such solutions may include Find My network by APPLE®, Find My Device by GOOGLE®, SmartThings by SAMSUNG®, and TILE®. While most of the existing solution are well suited for tracking inanimate objects, they are not suitable for tracking creatures (i.e., animate objects, for example, people or animals). Creatures have unpredictable behaviour in multiple scenarios and situations, and existing solutions are not equipped to account for these for accurate tracking.

One of the scenarios of significant concern is an unaccompanied minor or a differently abled person travelling by an airplane. The airport staff have to ensure their safety and well-being. Moreover, the airport staff may have specific protocols for such unaccompanied individuals, which typically involve support and additional supervision throughout their journey. However, such unaccompanied individuals may get lost during their pre-boarding procedures and some mishappening may also occur. The existing solutions are not designed or equipped for the aforementioned scenarios.

Furthermore, the existing solutions are restricted by proprietary technologies and lack the flexibility for scenario specific customization. The existing tracking solutions also fail to provide open Application Programming Interface (APIs) or Software Development Kit (SDKs) that may enable airport staff, for example, to integrate a tracking system into an existing workflow seamlessly.

Therefore, there is a need of tracking solutions that effectively track creatures in real-time within an airport and ensure safety of the creatures by streamlining communication between the airport staff, the creatures, and guardians.

### SUMMARY

In an embodiment, a method for monitoring creatures in airports using Bluetooth Low Energy (BLE) tags is disclosed. The method may include retrieving details of a creature in an airport based on a boarding pass associated with the creature. The method may further include mapping details of the creature to a tag configured to be worn by the creature. The tag includes a BLE beacon, an accelerometer, and a sound emitter. The method may further include iteratively receiving a first signal from the BLE beacon of the tag worn by the creature. The method may include determining a distance of the tag from an end-device based on the first signal. The method may further include displaying a colour-coded distance zone from a set of colour-coded distance zones, based on the determined distance. Each of the set of colour-coded distance zones are associated with a predefined range of the tag relative to the end-device.

In another embodiment, a method for monitoring creatures in airports using BLE tags is disclosed. The method may include detecting an activity pattern associated with a creature associated with a tag. The method may further include determining an activity based on analysis of the activity pattern. The method may include transmitting a second signal to an end-device. The second signal may be processed by the end-device to display the determined activity, via a display of the end-device.

In yet another embodiment, an end-device for monitoring creatures in airports using BLE tags is disclosed. The end-device may include a processor, and a memory coupled to the processor. The memory includes processor instructions, which when executed by the processor, cause the processor to retrieve details of a creature in an airport based on a boarding pass associated with the creature. The processor instructions further cause the processor to map details of the creature to a tag configured to be worn by the creature. The tag may include a BLE beacon and an accelerometer. The processor instructions cause the processor to iteratively receive a first signal from the BLE beacon of the tag worn by the creature. The processor instructions further cause the processor to determine a distance of the tag form an end-device based on the first signal. The processor instructions cause the processor to display a colour-coded distance zone selected from a set of colour-coded distance zones based on the determined distance. Each of the set of colour-coded distance zones may be associated with a predefined distance range of the tag relative to the end-device.

In another embodiment, a BLE tag is disclosed. The BLE tag may include an accelerometer to detect an activity pattern associated with a creature associated with the tag. The BLE tag may further include an A.I. model to determine an activity based on the analysis of the activity pattern. The BLE tag may further include a BLE beacon to transmit a first signal to an end-device. The first signal may be processed by the end-device to display the determined activity, via a display of the end-device.

It is to be understood that both the foregoing general description and the following detailed description are exemplary and explanatory only and not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary environment where various embodiments may be deployed.

FIG. 2 is a functional block diagram depicting communication between an end-device and a tag, in accordance with some embodiments of the present disclosure.

FIG. 3 illustrates Graphical User Interfaces (GUIs) displaying current location of a tag on a display of an end-device, in accordance with some embodiments of the present disclosure.

FIG. 4 illustrates GUI displaying a danger zone on a display of an end-device and subsequent broadcasting of a signal to a set of end-devices, in accordance with some embodiments of the present disclosure.

FIG. 5 illustrates a flowchart of an exemplary control logic for monitoring creatures in airports using Bluetooth Low Energy (BLE) tags, in accordance with some embodiments of the present disclosure.

FIG. 6 illustrates a flowchart of an exemplary control logic for determining an activity pattern associated with a creature, in accordance with some embodiments of the present disclosure.

FIG. 7 illustrates a flowchart of an exemplary control logic for transmitting a signal in response to identifying an alert zone, in accordance with some embodiments of the present disclosure.

FIG. 8 illustrates a flowchart of an exemplary control logic for instructing end-devices to identify a tag based on a tag Identifier (ID), in accordance with some embodiments of the present disclosure.

FIG. 9 illustrates a flowchart of an exemplary control logic for determining activity pattern of creatures in airports using BLE tags, in accordance with some embodiments of the present disclosure.

FIG. 10 illustrates a flowchart of an exemplary control logic for initiating an alarm mechanism in the tag, in accordance with some embodiments of the present disclosure.

FIG. 11 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

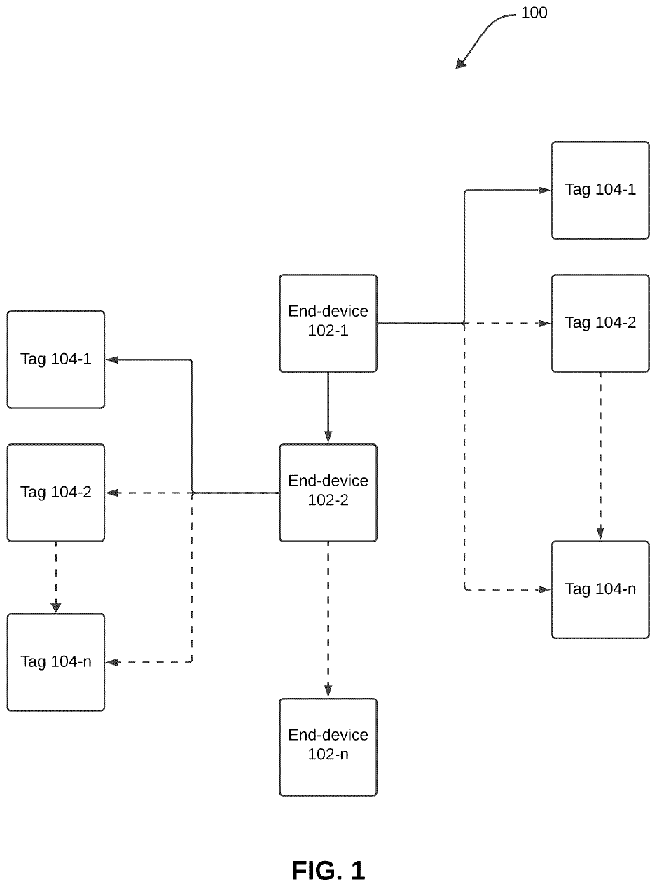

Referring now to FIG. 1, an exemplary environment 100 where various embodiments may be deployed is illustrated. The environment 100 may include a set of end-devices 102 (for example, an end-device 102-1, an end-device 102-2, and so on up to an end-device 102-n) and a set of tags 104 (for example, a tag 104-1, a tag 104-2, a tag 104-3, and so on up to a tag 104-n). The set of end-devices 102, for example, may be Internet of Things (IoT) devices, servers, desktops, laptops, notebooks, netbooks, tablets, smartphones, mobile phones, or any other computing devices. Further, each of the set of tags 104 may be Bluetooth Low Energy (BLE) based tags. Each of the set of end-devices 102 may be communicatively coupled to one or more of the set of tags 104 at different times based on initial configuration and distance from a respective tag from the set of tags 104. Each of the set of tags 104 may be attached to a creature (for example, an unassisted minor, a differently abled person, an aged person, or a pet) or an inanimate object (for example, luggage, a laptop, an entity, an equipment, a tool). Since each of the set of tags 104 is communicatively coupled to one or more of the set of end-devices 102, a given tag 104-1 may be used to track the creature or the inanimate object to which the tag 104-1 is attached thereto. However, the creature or the inanimate object may move out of a predefined distance range from the end-device 102-1 to which the tag 104-1 is communicatively coupled to. In such a scenario, the end-device 102-1 may not be able to track the creature or the inanimate object.

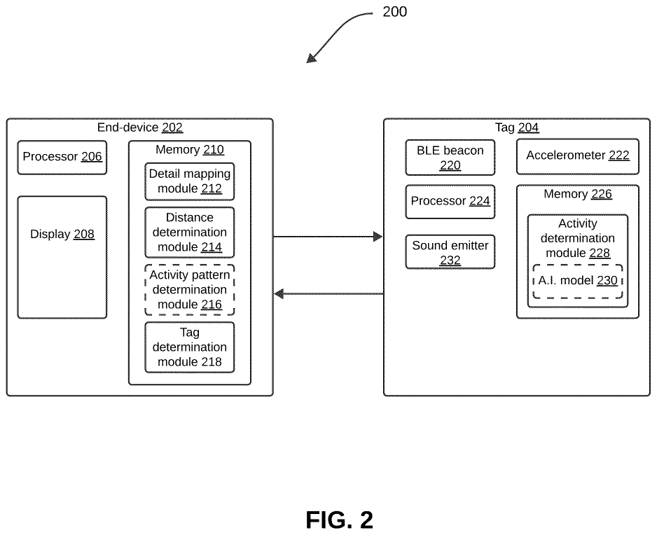

Referring now to FIG. 2, a functional block diagram depicting communication between an end-device 202 and a tag 204 is illustrated, in accordance with some embodiments of the present disclosure. Examples of the end-device 202 may include but are not limited to Internet of Things (IoT) devices, servers, desktops, laptops, notebooks, netbooks, tablets, smartphones, mobile phones, or any other computing devices. Examples of the tag 204 may include, but are not limited to BLE based tags, Radio frequency tags, Ultra-Wide Band (UWB) tags, Wireless Fidelity (Wi-Fi) location tags, Near field Communication (NFC) tags, or infrared location tags. The tag 204 may be attached to a creature within an airport. By way of an example, the tag 204 may be part of a wearable device, like, a watch, a band, a pendant, or a ring. The end-device 202 may be communicatively coupled to the tag 204 using a wireless communication protocol. Examples of the wireless communication protocol may include, but are not limited to BLE, Wi-Fi, Zigbee, Z-wave, or NFC.

The end-device 202 may include a processor 206, a display 208, and a memory 210. The memory 210 may further include a detail mapping module 212, a distance determination module 214, an activity pattern determination module 216, and a tag determination module 218. The tag 204 may include a BLE beacon 220, a processor 224, a sound emitter 232, an accelerometer 222, and a memory 226. When BLE is used as the wireless communication protocol, the BLE beacon 220 may be used to send signals to the coupled end-device 202 with low energy consumption. The memory 226 may include an activity determination module 228 that may further include an Artificial Intelligence (AI) model 230.

The detail mapping module 212 may retrieve details of a creature in an airport based on a boarding pass associated with the creature. The details of the creature may include, but may not be limited to a name, age, a flight to be boarded, time of boarding, and a final destination, and a tag identifier (ID). Thereafter, the detail mapping module 212 may map the retrieved details of the creature to a tag ID of the tag 204 that is to be worn by the creature. The tag 204 may include the BLE beacon 220, the accelerometer 222, and the sound emitter 232. The end-device 202 is also communicably coupled with the tag 204, such that, the end-device 202 is able to track the current location of the tag 204. The tag 204 may be communicably coupled with the end-device using Bluetooth.

Once the end-device 202 is communicably coupled with the tag 204, the distance determination module 214 may continuously receive a first signal from the BLE beacon 220. Based on the received first signal, the distance determination module 214 may determine a distance of the tag 204 from the end-device 202. The display 208 may then render a colour-coded distance zone selected from a set of colour-coded distance zones, based on the determined distance. Each of the set of colour-coded distance zones are associated with the predefined distance range of the tag 204 relative to the end-device 202. It will be apparent that each colour-coded distance zone has a specific colour associated with it and the display 208 may renders the specific colour that is associated with an identified colour-coded distance zone.

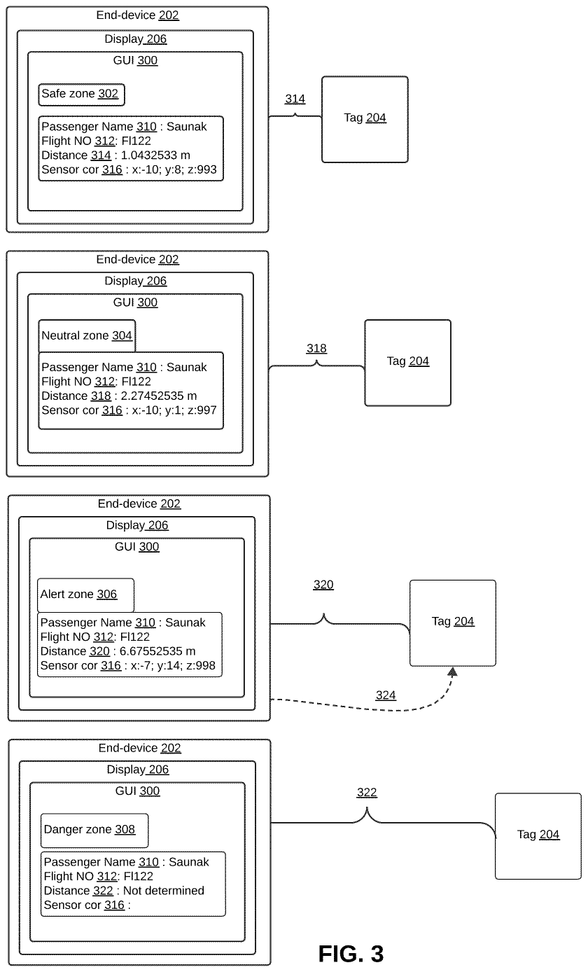

The set of colour-coded distance zones may include, but are not limited to a safe zone, a neutral zone, an alert zone, and a danger zone. The safe zone may correspond to the distance being less than or equal to a first threshold. The safe zone, for example, maybe associated with green colour. The neutral zone may correspond to the distance being greater than the first threshold and less than or equal to a second threshold. The neutral zone, for example, maybe associated with yellow colour. The alert zone may correspond to the distance being greater than the second threshold and less than or equal to a third threshold. The alert zone, for example, maybe associated with orange colour. Lastly, the danger zone may correspond to the distance being greater than the third threshold. The danger zone, for example, maybe associated with amber colour. This is further explained in detail in conjunction with FIG. 3.

In addition to the first signal that is used to determine distance of the tag 204 from the end-device, the activity pattern determination module 216 may receive a second signal from the tag 204. The second signal is generated by the BLE beacon 220 and may include details of the activity pattern detected by the accelerometer 222. The activity pattern determination module 216 may further determine an activity being performed by the creature based on analysis of the details of an activity pattern in the second signal. The analysis may be performed by an AI model in the activity pattern determination module 216. Additionally, if the alert zone is identified as the colour-coded distance zone to be displayed via the display 208 of the end-device 202, the activity pattern determination module 216 may transmit a third signal to the tag 204. The third signal may be configured to initiate an alarm mechanism in the sound emitter 232, thereby notifying the creature or collocated individuals near the creature that the creature is moving farther away from the end-device 202. In some embodiments, sound intensity of the alarm may gradually increase as the distance of the tag 204 from the end-device 202 increases.

When the danger zone is identified as the colour-coded distance zone to be displayed on the display 208, the tag determination module 218 may initiate a timer. The tag determination module 218 may further determine expiry of a predefined time interval since initiation of the time. On expiry of the predefined time interval, the tag determination module 218 may generate a fourth signal. The tag determination module 218 may then broadcast a fifth signal to a set of end-devices 102 associated with the end-device 202 in the airport. The fifth signal may include details related to the tag ID of the tag 204 and the last know location of the tag 204. The fifth signal may be configured to enable each of the set of end-devices 102 to identify the tag 204 based on the tag ID, if and when the tag 204 is withing respective coverage area of one of the set of end-devices 102. If at least one of the set of end-devices 102 detect the tag 204, the tag determination module 218 may receive a sixth signal from the at least one of the set of end-devices 102. The sixth signal may include current location details of the tag 204.

In an embodiment, at the tag 204, the activity determination module 228 may detect an activity pattern of the creature, based on movement data of the creature as captured by the accelerometer 222. The AI model 230 may further analyse the activity pattern to determine an activity performed by the creature. Examples of the activity may include but are not limited to tag removed from the creature, the creature fell down, the creature not moving, and the creature running at a speed not suitable for his/her age. By way of an example, if an adult may be running after kidnapping a minor, the speed of the creature (the minor) may be indicated as being unnatural. Accordingly, the activity determination module 228 may transmit a second signal, which includes details of the activity, to the end-device 202 via the BLE beacon 220. The second signal may be processed by the end-device 202 to display the determined activity, via the display 208 of the end-device 202. In some embodiments, the second signal may only include details of the movement data captured by the accelerometer 222. In this case, the activity determination module 216 may determine the activity performed by the creature.

It should be noted that all such aforementioned modules 212, 214, 216, 218, 228 and 230 may be represented as a single module or a combination of different modules. Further, as will be appreciated by those skilled in art, each of the modules 212, 214, 216, 218, 228 and 230 may reside, in whole or in parts, on one device or multiple devices in communication with each other. In some embodiments, each of the modules 212, 214, 216, 218, 228 and 230 may be implemented as dedicated hardware circuit comprising custom application-specific integrated circuit (ASIC) or gate arrays, off-the-shelf semiconductors such as logic chips, transistors, or other discrete components. Each of the modules 212, 214, 216, 218, 228 and 230 may also be implemented in a programmable hardware device such as a field programmable gate array (FPGA), programmable array logic, programmable logic device, and so forth. Alternatively, each of the modules 212, 214, 216, 218, 228 and 230 may be implemented in software for execution by various types of processors (e.g., the processor 206 or the processor 224). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for method, device, and system for monitoring creatures in airports using BLE tags. For example, the exemplary system 200 may monitor creatures in airports using BLE tags by the processes discussed herein. In particular, as will be appreciated by those of ordinary skill in the art, control logic and/or automated routines for performing the techniques and steps described herein may be implemented by the system 200 either by hardware, software, or combinations of hardware and software. For example, suitable code may be accessed and executed by one or more processors on the system 200 to perform some or all of the techniques described herein. Similarly, application specific integrated circuits (ASICs) configured to perform some, or all of the processes described herein may be included in the one or more processors on the system 200.

Referring now to FIG. 3, a Graphical User Interface (GUI) 300 displaying current location of the tag 204 on the display 208 of the end-device 202 is illustrated, in accordance with some embodiments of the present disclosure. As discussed before, the end-device 202 may be communicably coupled with the tag 204. The GUI 300, via the display 208, may render a colour-coded distance zone selected from a set of colour-coded distance zones, based on a distance determined between the end-device 202 and the tag 203. Each of the set of colour-coded distance zones are associated with a predefined distance range of the tag 204 relative to the end-device 202 as discussed earlier.

The set of colour-coded distance zones may include a safe zone 302, a neutral zone 304, an alert zone 306, and a danger zone 308. The safe zone 302 may be identified when a distance 314 between the end-device 202 and the tag 204 is less than or equal to a first threshold. The neutral zone 304 may be identified when a distance 318 between the end-device 202 and the tag 204 is greater than the first threshold and less than or equal to a second threshold. The alert zone 306 may be identified when a distance 320 between the end-device 202 and the tag 204 is greater than the second threshold and less than or equal to a third threshold. Lastly, the danger zone 308 may be identified when a distance 322 between the end-device 202 and the tag 204 is greater than the third threshold. In addition to displaying the colour-coded distance zone, the GUI may display the details of the creature using the detail mapping module 212. Details associated with the creature may include, but are not limited to a passenger name 310, one of the distances 314, 318, 320 and 322, a flight number 312, coordinates 316, and the tag ID of the tag 204.

In some embodiments, when the alert zone 306 is identified based on the distance 320, the end-device 202 may transmit a third signal 324 to the tag 204. The BLE beacon 220 of the tag 204 may receive the third signal 324 and, in response, may initiate an alarm mechanism through the sound emitter 232 of the tag 204. In an embodiment, the tag 204 may also include a vibrator motor that may also be activated in response to receiving the third signal 324.

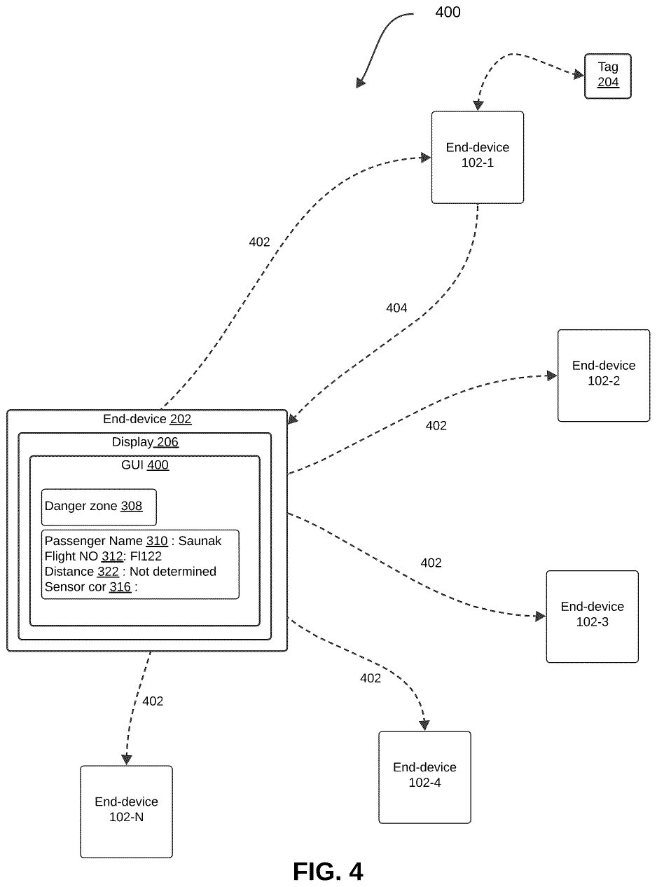

Referring now to FIG. 4, a GUI 400 displaying the danger zone 308 on the display 206 of the end-device 202 and subsequent broadcasting of a fifth signal 402 to the set of end-devices 102 is illustrated, in accordance with some embodiments of the present disclosure. In response to the danger zone 308 being identifying as the colour-coded distance zone to be displayed on GUI 400, the end-device 202 may initiate a timer. After expiry of a predefined time interval since initiation of the timer, the end-device 202 may broadcast a fifth signal 402 to the set of end-devices 102, which are associated with the end-device 202 in the airport. The fifth signal 402 may include a tag ID of the tag 204 and the last known location of the tag 204. The fifth signal 402 may be configured to enable each of the set of end-devices 102 to identify the tag 204 based on the tag ID, when the tag 204 is within respective coverage area. In an embodiment, the end-device 102-1 may detect the tag 204 within its coverage area and in response may generate a sixth signal 404 for the end-device 202. The sixth signal 404 may include the current location details of the tag 204.

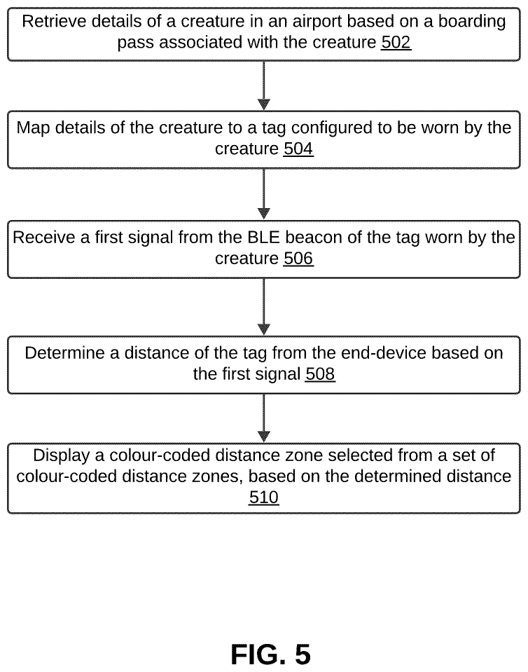

Referring now to FIG. 5, an exemplary control logic for monitoring creatures in airports using BLE tags is depicted via a flowchart, in accordance with some embodiments of the present disclosure. At step 502, details of a creature in an airport are retrieved based on a boarding pass associated with the creature. Thereafter, at step 504, details of the creature are mapped to the tag 204 configured to be worn by the creature.

At step 506, a first signal is received from the BLE beacon 220 of the tag 204 worn by the creature. Based on the first signal, a distance of the tag 204 from the end-device 202 is determined at step 508. Based on the determined distance, a colour-coded distance zone from the set of colour-coded distance zones may be displayed at step 510. Each of the set of colour-coded distance zones are associated with the predefined distance range of the tag 204 relative to the end-device 202. The set of colour-coded distance zones may include, but are not limited to a safe zone, a neutral zone, an alert zone, and a danger zone. The safe zone may correspond to the distance being less than or equal to a first threshold. The neutral zone may correspond to the distance being greater than the first threshold and less than or equal to a second threshold. The alert zone may correspond to the distance being greater than the second threshold and less than or equal to a third threshold. Lastly, the danger zone may correspond to the distance being greater than the third threshold. This has already been explained in detail conjunction with FIG. 2 and FIG. 3.

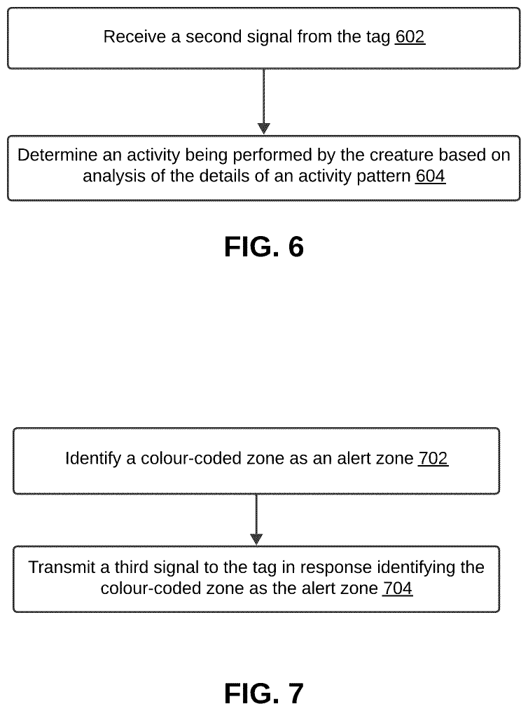

Referring now to FIG. 6, an exemplary control logic for determining an activity pattern associated with a creature is depicted via a flowchart, in accordance with some embodiments of the present disclosure. At step 602, a second signal is received from the tag 204 by the end-device 202. The second signal may be generated by the BLE beacon 220 and may include details of the activity pattern detected by the accelerometer 222. Thereafter, at step 604, activity being performed by the creature is determined based on the analysis of the details of the activity pattern by an AI model in the end-device 202. This has already been explained in detail conjunction with FIG. 2.

Referring now to FIG. 7, an exemplary control logic for transmitting a third signal in response to identifying a colour-coded distance zone as an alert zone is depicted via a flowchart, in accordance with some embodiments of the present disclosure. As discussed before, based on the distance between the tag 204 and the end-device 202, a colour-coded distance zone may be identified. In the current embodiment, at step 702, the colour-coded distance zone is identified as the alert zone. The alert zone may correspond to the distance being greater than a second threshold and less than or equal to a third threshold. In response to identifying the colour-coded distance zone as the alert zone, a third signal is transmitted to the tag 204 at step 704. The third signal may be configured to initiate an alarm mechanism in the sound emitter 232, thereby notifying the creature or collocated individuals near the creature that the creature is moving farther away from the end-device 202. This has already been explained in detail conjunction with FIG. 3.

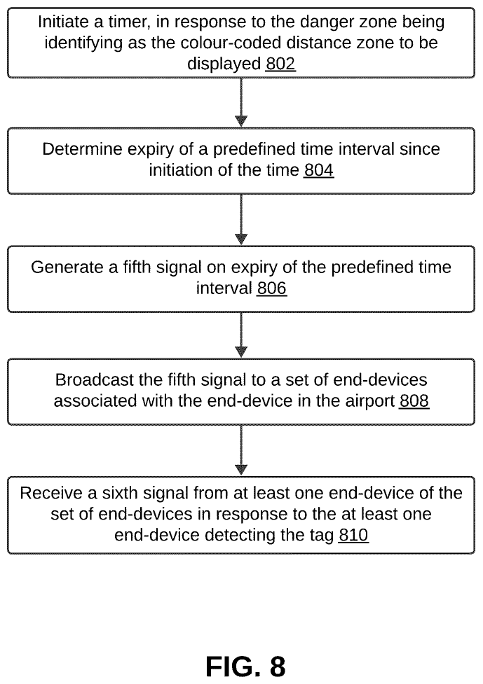

Referring now to FIG. 8, an exemplary control logic for instructing a set of end-devices 102 to identify the tag 204 based on a tag ID of the tag 204 is depicted via a flowchart, in accordance with some embodiments of the present disclosure. In response to a danger zone being identifying as the colour-coded distance zone to be displayed via the display 208, a timer may be initiated at step 802. At step 804, expiry of a predefined time interval since initiation of the timer may be determined. After expiry of the predefined time interval, the fifth signal 402 may be generated at step 806. The fifth signal 402 may then be broadcasted to the set of end-devices 102 associated with the end-device 202 in the airport, at step 808. Thereafter, at step 810, the sixth signal 404 may be received from at least one end-device from the set of end-devices 102 that have detected the tag 204 in its vicinity. The sixth signal 404 may include current location details of the tag 204. This has already been explained in detail conjunction with FIG. 4.

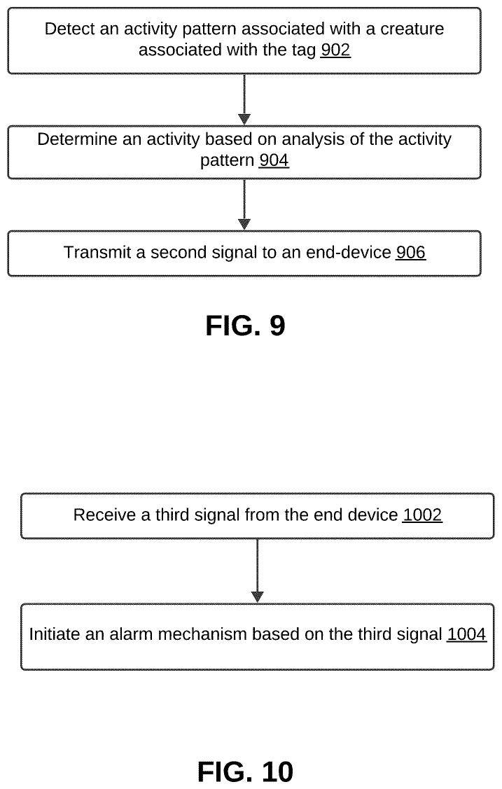

Referring now to FIG. 9, an exemplary control logic for determining activity pattern of creatures in airports using BLE tags is depicted via a flowchart, in accordance with some embodiments of the present disclosure. At step 902, an activity pattern of a creature associated with the tag 204 may be detected by the accelerometer 222 in the tag 204. Based on an analysis of the activity pattern by the AI model 230, an activity associated with the creature is determined by the AI model 230 at step 904. Thereafter, a second signal is transmitted by the BLE beacon 220 to the end-device 202, at step 906. The second signal is then processed by the end-device 202 to display the determined activity, via the display 208 of the end-device 202. This has already been explained in detail conjunction with FIG. 2.

Referring now to FIG. 10, an exemplary control logic for initiating an alarm mechanism in the tag 204 is depicted via a flowchart, in accordance with some embodiments of the present disclosure. In some embodiments, when an alert zone is identified as the colour-coded distance zone to be displayed by the end-device 202, the third signal 324 may be transmitted by the end-device 202. At step 1002, the third signal 324 is received by the BLE beacon 220 in the tag 204. Based on the third signal 324, an alarm mechanism may be initiated by the tag 204 via the sound emitter 232. This has already been explained in detail conjunction with FIG. 2 and FIG. 3.

As will also be appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

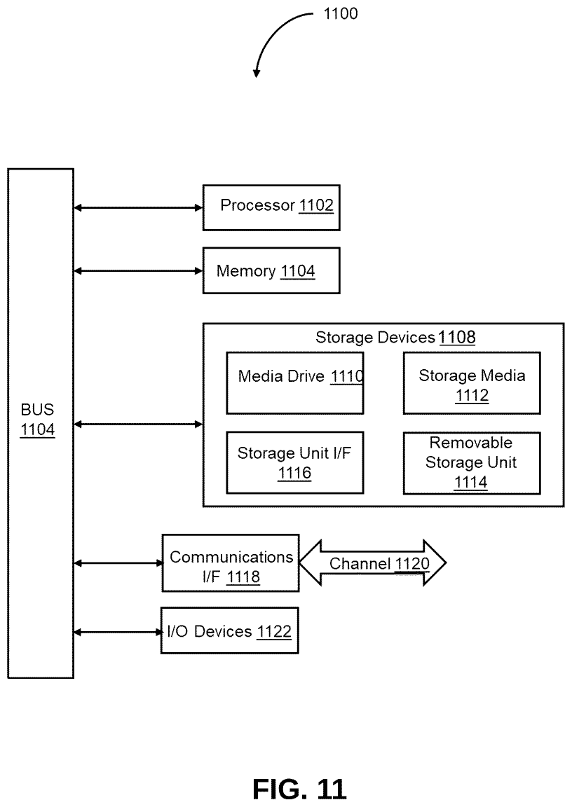

The disclosed methods and systems may be implemented on a conventional or a general-purpose computer system, such as a personal computer (PC) or server computer. Referring now to FIG. 11, an exemplary computing system 1100 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1100 may represent, for example, a user device such as a desktop, a laptop, a mobile phone, personal entertainment device, DVR, and so on, or any other type of special or general-purpose computing device as may be desirable or appropriate for a given application or environment. The computing system 1100 may include one or more processors, such as a processor 1102 that may be implemented using a general or special purpose processing engine such as, for example, a microprocessor, microcontroller or other control logic. In this example, the processor 1102 is connected to a bus 1104 or other communication medium. In some embodiments, the processor 1102 may be an Artificial Intelligence (AI) processor, which may be implemented as a Tensor Processing Unit (TPU), or a graphical processor unit, or a custom programmable solution Field-Programmable Gate Array (FPGA).

The computing system 1100 may also include a memory 1106 (main memory), for example, Random Access Memory (RAM) or other dynamic memory, for storing information and instructions to be executed by the processor 1102. The memory 1106 also may be used for storing temporary variables or other intermediate information during execution of instructions to be executed by the processor 1102. The computing system 1100 may likewise include a read only memory (“ROM”) or other static storage device coupled to bus 1104 for storing static information and instructions for the processor 1102.

The computing system 1100 may also include a storage device 1108, which may include, for example, a media drive 1110 and a removable storage interface. The media drive 1110 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1112 may include, for example, a hard disk, magnetic tape, flash drive, or other fixed or removable medium that is read by and written to by the media drive 1110. As these examples illustrate, the storage media 1112 may include a computer-readable storage medium having stored there in particular computer software or data.

In alternative embodiments, the storage devices 1108 may include other similar instrumentalities for allowing computer programs or other instructions or data to be loaded into the computing system 1100. Such instrumentalities may include, for example, a removable storage unit 1114 and a storage unit interface 1116, such as a program cartridge and cartridge interface, a removable memory (for example, a flash memory or other removable memory module) and memory slot, and other removable storage units and interfaces that allow software and data to be transferred from the removable storage unit 1114 to the computing system 1100.

The computing system 1100 may also include a communications interface 1118. The communications interface 1118 may be used to allow software and data to be transferred between the computing system 1100 and external devices. Examples of the communications interface 1118 may include a network interface (such as an Ethernet or other NIC card), a communications port (such as for example, a USB port, a micro-USB port), Near field Communication (NFC), etc. Software and data transferred via the communications interface 1118 are in the form of signals which may be electronic, electromagnetic, optical, or other signals capable of being received by the communications interface 1118. These signals are provided to the communications interface 1118 via a channel 1120. The channel 1120 may carry signals and may be implemented using a wireless medium, wire or cable, fiber optics, or other communication mediums. Some examples of the channel 1120 may include a phone line, a cellular phone link, an RF link, a Bluetooth link, a network interface, a local or wide area network, and other communications channels.

The computing system 1100 may further include Input/Output (I/O) devices 1122. Examples may include, but are not limited to a display, keypad, microphone, audio speakers, vibrating motor, LED lights, etc. The I/O devices 1122 may receive input from a user and also display an output of the computation performed by the processor 1102. In this document, the terms “computer program product” and “computer-readable medium” may be used to generally refer to media such as, for example, the memory 1106, the storage devices 1108, the removable storage unit 1114, or signal(s) on the channel 1120. These and other forms of computer-readable media may be involved in providing one or more sequences of one or more instructions to the processor 1102 for execution. Such instructions, generally referred to as “computer program code” (which may be grouped in the form of computer programs or other groupings), when executed, enable the computing system 1100 to perform features or functions of embodiments of the present invention.

In an embodiment where the elements are implemented using software, the software may be stored in a computer-readable medium and loaded into the computing system 1100 using, for example, the removable storage unit 1114, the media drive 1110 or the communications interface 1118. The control logic (in this example, software instructions or computer program code), when executed by the processor 1102, causes the processor 1102 to perform the functions of the invention as described herein.

Thus, the disclosed method and system try to overcome the technical problem for monitoring creatures in airports using Bluetooth Low Energy (BLE) tags. As will be appreciated by those skilled in the art, the techniques described in the various embodiments discussed above are not routine, or conventional, or well understood in the art. The techniques discussed above provide for monitoring creatures in airport using BLE tags. The techniques utilize the open and widely adopted BLE standards. The techniques ensure compatibility with a broad range of beacons from various manufactures, avoiding vendor lock-in. The techniques rely on open-source libraries for Received Signal Strength Indicators (RSSI) data interpretation, reducing dependency on proprietary Software Development Kit (SDKs) or Application Programming Interface (APIs) and allowing for greater flexibility in customization and integration. The techniques enable the BLE beacons to be designed for low power consumption, which contributes to their extended battery life. These techniques are particularly advantageous for maintaining long-term operations without frequent maintenance or battery replacements. The techniques leverage cost-effective BLE beacons and may be implemented using existing smartphone devices, reducing the need for additional hardware investments, and making it accessible for airlines of all sizes. The techniques may provide real-time location tracking and immediate alerts for any deviations from expected proximity or sudden movements.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for monitoring creatures in airports using Bluetooth Low Energy (BLE) tags. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for monitoring creatures in airports using Bluetooth Low Energy (BLE) tags, the method comprising:
retrieving, by an end-device, details of a creature in an airport based on a boarding pass associated with the creature;
mapping, by the end-device, details of the creature to a tag configured to be worn by the creature, wherein the tag comprises a BLE beacon, an accelerometer and a sound emitter;
iteratively receiving, by the end-device, a first signal from the BLE beacon of the tag worn by the creature;
determining, by the end-device, a distance of the tag from the end-device based on the first signal; and
displaying, on a Graphical User Interface (GUI) of the end-device, a colour-coded distance zone selected from a set of colour-coded distance zones, based on the determined distance, wherein each of the set of colour-coded distance zones are associated with a predefined distance range of the tag relative to the end-device.

2. The method of claim 1, further comprising:
receiving, by the end-device, a second signal from the tag, wherein the second signal is generated by the BLE beacon and comprises details of an activity pattern detected by the accelerometer; and
determining, by an AI model in the end-device, an activity being performed by the creature based on analysis of the details of the activity pattern in the second signal.

3. The method of claim 1, wherein the set of colour-coded distance zones comprises:
a safe zone, wherein the safe zone corresponds to the distance being less than or equal to a first threshold;
a neutral zone, wherein the neutral zone corresponds to the distance being greater than the first threshold and less than or equal to a second threshold;
an alert zone, wherein the alert zone corresponds to the distance being greater than the second threshold and less than or equal to a third threshold; and
a danger zone, wherein the danger zone corresponds to the distance being greater than third threshold.

4. The method of claim 3, further comprising transmitting, by the end-device, a third signal to the tag, in response to the alert zone being identified as the colour-coded distance zone to be displayed, wherein the third signal is configured to initiate an alarm mechanism in the sound emitter of the tag.

5. The method of claim 3, further comprising:
initiating, by the end-device, a timer, in response to the danger zone being identifying as the colour-coded distance zone to be displayed;
determining expiry of a predefined time interval since initiation of the time;
generating, by the end-device, a fifth signal on expiry of the predefined time interval.

6. The method of claim 5, further comprising:
broadcasting, by the end-device, the fifth signal to a set of end-devices associated with the end-device in the airport, wherein the fifth signal comprises a tag Identifier (ID) of the tag and is configured to enable each of the set of end-devices to identify the tag based on the tag ID; and
receiving, by the end-device, a sixth signal from at least one end-device of the set of end-devices in response to the at least one end-device detecting the tag, wherein the sixth signal comprises current location details of the tag.

7. A method for monitoring creatures in airports using Bluetooth Low Energy (BLE) tags, the method comprising:
detecting, by an accelerometer in a tag, an activity pattern associated with a creature associated with the tag;
determining, by an AI model in the tag, an activity based on analysis of the activity pattern; and
transmitting, by a BLE beacon in the tag, a second signal to an end-device, wherein the second signal is processed by the end-device to display the determined activity, via a display of the end-device.

8. The method of claim 7, further comprising receiving, by the BLE beacon, a third signal from the end-device, wherein the end-device transmits the third signal in response to an alert zone being identified as one a set of colour-coded distance zone to be displayed by the end-device, and wherein each of the set of colour-coded distance zones are associated with a predefined distance range of the tag relative to the end-device.

9. The method of claim 8, further comprising initiating, by the tag, an alarm mechanism in the sound emitter based on the third signal.

10. An end-device for monitoring creatures in airports using Bluetooth Low Energy (BLE) tags, the end-device comprising:
a processor; and
a memory communicatively coupled to the processor, wherein the memory stores processor-executable instructions, which when executed by the processor, cause the processor to:
retrieve details of a creature in an airport based on a boarding pass associated with the creature;
map details of the creature to a tag configured to be worn by the creature, wherein the tag comprises a BLE beacon, an accelerometer and a sound emitter;
iteratively receive a first signal from the BLE beacon of the tag worn by the creature;
determine a distance of the tag from the end-device based on the first signal; and
display a colour-coded distance zone selected from a set of colour-coded distance zones based on the determined distance, wherein each of the set of colour-coded distance zones are associated with a predefined distance range of the tag relative to the end-device.

11. The end-device of claim 10, wherein the processor instructions further cause the processor to:
receive a second signal from the tag, wherein the second signal is generated by the BLE beacon and comprises details of an activity pattern detected by the accelerometer; and
determine, via an AI module, an activity being performed by the creature based on analysis of the details of the activity pattern in the second signal.

12. The end-device of claim 10, wherein the set of colour-coded distance zones comprises:
a safe zone, wherein the safe zone corresponds to the distance being less than or equal to a first threshold;
a neutral zone, wherein the neutral zone corresponds to the distance being greater than the first threshold and less than or equal to a second threshold;
an alert zone, wherein the alert zone corresponds to the distance being greater than the second threshold and less than or equal to a third threshold; and
a danger zone, wherein the danger zone corresponds to the distance being greater than third threshold.

13. The end-device of claim 12, wherein the processor instructions further cause the processor to transmit a third signal to the tag, in response to the alert zone being identified as the colour-coded distance zone to be displayed, wherein the third signal is configured to initiate an alarm mechanism in the sound emitter of the tag.

14. The end-device of claim 12, wherein the processor instructions further cause the processor to:
initiate a timer, in response to the danger zone being identifying as the colour-coded distance zone to be displayed;
determine expiry of a predefined time interval since initiation of the time; and
generate a fourth signal on expiry of the predefined time interval.

15. The end-device of claim14, wherein the processor instructions further cause the processor to:
broadcast a fifth signal to a set of end-devices associated with the end-device in the airport, wherein the fifth signal comprises a tag Identifier (ID) of the tag and is configured to enable each of the set of end-devices to identify the tag based on the tag ID; and
receive a sixth signal from at least one end-device of the set of end-devices in response to the at least one end-device detecting the tag, wherein the sixth signal comprises current location details of the tag.

16. A Bluetooth Low Energy (BLE) tag comprising:
an accelerometer in a tag configured to detect an activity pattern associated with a creature associated with the tag;
an AI model in the tag configured to determine an activity based on the analysis of the activity pattern; and
a BLE beacon in the tag configured to transmit the first signal to an end-device, wherein the first signal is processed by the end-device to display the determined activity, via a display of the end-device.

17. The BLE tag of claim 16, wherein the BLE beacon further configured to receive a third signal from the end-device, wherein the end-device transmits the third signal in response to an alert zone being identified as one a set of colour-coded distance zone to be displayed by the end-device, and wherein each of the set of colour-coded distance zones are associated with a predefined distance range of the tag relative to the end-device.

18. The BLE tag of claim 17, wherein the BLE tag further configured to initiate an alarm mechanism in the sound emitter based on the third signal.
